(19) United States
(12) Patent Application Publication
(10) Pub. No.: US 2013/0189428 A1
(43) Pub. Date: Jul. 25, 2013

(54) METHOD FOR TRANSFERRING TARGET PARTICLES BETWEEN SUBSTRATES

(71) Applicants: Cedric Troadec, Singapore (SG); Jie Deng, Singapore (SG); Christian Joachim, Singapore (SG)

(72) Inventors: Cedric Troadec, Singapore (SG); Jie Deng, Singapore (SG); Christian Joachim, Singapore (SG)

(21) Appl. No.: 13/535,315

(22) Filed: Jun. 27, 2012

(30) Foreign Application Priority Data
Jun. 27, 2011 (SG) 201104736-2

(51) Int. Cl. B05D 1/28

(52) U.S. Cl. CPC B05D 1/28
USPC 427/180; 118/50

(57) ABSTRACT

The present disclosure relates to a method for transferring target particles between two substrates, the method comprising the steps of: (a) contacting a receiver substrate with a stamp substrate having the target particles disposed thereon to transfer said target particles to the receiver substrate; and (b) applying a vacuum to the contacting substrates during said contacting step to prevent non-target particles from being deposited onto said receiver substrate.

### TECHNICAL FIELD

The present disclosure relates to a method and system for transferring target particles from a stamp substrate to a receiver substrate, while maintaining atomic surface integrity and cleanliness of the receiver substrate.

### BACKGROUND

In the field of atomic scale electronics, a common technical challenge faced by industry relates to the need to assemble the various components required to fabricate the electronic device and connecting the fabricated device to the macroscopic world while substantially retaining the atomic surface cleanliness of the device. Maintaining the atomic surface cleanliness is important especially for nano-sized electronic devices as even slight contamination may prevent the device from functioning as intended.

In particular, continued miniaturization of electric components has resulted in a need to provide increasingly sophisticated systems and methods for fabricating and assembling these nano-sized devices, e.g., molecular sized processors.

Presently, various components of a nanoelectric device may be fabricated separately and subsequently assembled to form the product device. For instance, in order to produce a microchip, an organic wafer substrate may undergo initial processing using conventional nano-imprint technology to provide nanostructures on its wafer surface. Typically, this is accomplished by nano-imprinting an organic substrate under ambient conditions (atmospheric pressure). The imprinting step usually involves pressing a pre-patterned mold against a substrate surface under suitable thermal or optical excitation to effect the transfer of the pre-patterned features onto the recipient substrate's surface.

The imprinted substrate may then be further etched or molded, and subsequently assembled ex-situ with other nano-electronic components to form the nanoelectric device.

One drawback of the method above is that the atomic resolution of the recipient substrate surface cannot be retained due to contamination by the presence of other molecular or atomic particles during the imprinting step itself and/or during the ex-situ assembly step.

Furthermore, nanoelectric devices may require the formation of atomic/molecular sized features to act as atomic wires or other forms of atomic electrical connections. However, such precision cannot be achieved by conventional techniques, such as e-beam lithography, nanostencil technique, etc.

Additionally, in some cases, it may be technically unfeasible to grow these atomic/molecular sized features directly on a substrate surface.

Therefore, there is a need to provide a method for imprinting substrates or to transfer target particles between substrates that overcomes or ameliorates the technical problem described above.

In particular, there is a need to provide a method for transferring target particles between substrate surfaces under suitable conditions so as to avoid contamination of the substrate surfaces and to allow the recipient substrate to retain its atomic features.

### SUMMARY

Accordingly, in a first aspect, there is provided a method for transferring target particles between two substrates, the method comprising the steps of: (a) contacting a receiver substrate with a stamp substrate having said target particles disposed thereon to transfer said target particles to said receiver substrate; and (b) applying a vacuum to said contacting substrates during said contacting step to prevent non-target particles from being deposited onto said receiver substrate.

In one embodiment, the applying step may comprise providing and sustaining a vacuum pressure of 100 nanoPascals (nPa) or lesser, under which the substrates are contacted under compressive force. Advantageously, this allows the stamp substrate and the receiver substrate to be contacted under ultra clean conditions which would avoid, or at the very least, reduce contamination by other atomic or molecular particles (non-target particles) present in a non-vacuum environment.

Advantageously, the step of applying the vacuum results in less non-target particles being deposited onto said receiver substrate relative to a contacting step in which the vacuum has not been applied.

Also advantageously, the disclosed method is especially useful in situations where the target particles from the stamp substrate could not have been readily deposited or grown via conventional ways (e.g., PVD, CVD, nanolithography, epitaxy, etc) on the receiver substrate.

In one embodiment, the applying step comprises applying an ultra-high vacuum (UHV) during the contacting step so that the receiver substrate is substantially absent of non-target particles. To verify that the receiver substrate has not been contaminated by non-target particles, characterization on the nanoscale may be performed by using Scanning Probe Microscopy (SPM), e.g., Atomic Force Microscopy (AFM) and Scanning Tunneling Microscopy (STM). For characterization of larger surface area, it is also possible to use Reflection high-energy electron diffraction (RHEED) or Low Energy Electron Diffraction (LEED).

The contacting step (a) may comprise supplying sufficient force to compress the stamp substrate and the receiver substrate to at least partially transfer target particles that were present on the stamp substrate surface to the receiver substrate. An advantage of the above disclosed method is that the transfer of target particles, e.g., metallic nanocrystals, from the stamp substrate onto an atomically defined receiver substrate can be performed without damaging the atomic order of the receiver substrate. That is, the disclosed method is capable of retaining the atomic features originally present on the receiver substrate surface.

In a second aspect, there is provided a system for transferring target particles between two substrates, said system comprising: (a) a chamber housing at least one stamp substrate and one receiver substrate therein, said stamp substrate having target particles disposed thereon; (b) pressing means configured to bring into contact said stamp substrate and said receiver substrate to transfer said target particles from said stamp substrate to said receiver substrate; and (c) vacuum means capable of generating negative pressure conditions in said chamber, wherein in use, said vacuum means applies a vacuum to said contacting stamp and receiver substrates to prevent non-target particles from being deposited onto said receiver substrate.

The pressing means may be actuated by an integrated electrical means or a mechanical means. The electrical means may be activated from outside of the chamber. Advantageously, the present system provides a controlled, isolated and clean environment wherein two substrates can be compressed or brought in contact together under critically controlled pressure conditions. In one embodiment, the vacuum means may be configured to provide and sustain pressures of 100 nanoPascals or lower within the chamber.

Further advantageously, the transfer of target particles may be performed in-situ without the need for external thermal or optical excitation. Still advantageously, the interior of the chamber and the substrates are not exposed to the external macro-environment and therefore reduces the risk of contamination by non-target particles.

### DEFINITIONS

The following words and terms used herein shall have the meaning indicated:

The prefix “nano” as used in the present specification, such as in the terms “nano-sized structures” or “nanostructures”, shall be taken to refer to structures having width and/or height dimensions between 10 nm to 1,500 nm. The prefix “micro”, and grammatical variants thereof, as used in the present specification, such as in the term “micron-sized”, shall be taken to refer to, unless otherwise specified, structures having width and/or height dimensions between 1 μm to 100 μm.

The term “negative pressure” may be used interchangeably with the term “vacuum” as used in the present specification and generally refers to a gaseous environment with a pressure below atmospheric pressure, i.e., less than one atmosphere (or about 101 kPa). The term “vacuum”, as used in the context of the present specification, is not intended to be limited to mean only a perfect vacuum, but is intended to mean also a relative vacuum with respect to the atmospheric or ambient pressure.

The terms “ultra high vacuum” or “UHV” as used in the context of the present specification refers to, unless otherwise specified, a gaseous environment with a base pressure of less than 100 nPa.

The term “atomically defined” as used in the present specification generally refers to a surface that possesses at least one atomic-scale or nano-scale or micro-scale barrier, cavity or step that disrupts an otherwise ordered atomic structure of the surface. The term “atomic-scale” refers to a barrier, cavity or step having a width and/or height of a single atom.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range

### DISCLOSURE OF OPTIONAL EMBODIMENTS

Exemplary, non-limiting embodiments of a method according to the first aspect will now be disclosed.

In one embodiment, the present disclosure provides a method for transferring target particles between two substrates, the method comprising the steps of: (a) contacting a receiver substrate with a stamp substrate having said target particles disposed thereon to transfer said target particles to said receiver substrate; and (b) applying a vacuum to said contacting substrates during said contacting step to prevent non-target particles from being deposited onto said receiver substrate.

The applying step (b) may comprises applying a vacuum pressure of 100 nPa or lower. Preferably, the vacuum should be provided and sustained at pressures less than 100 nPa, less than 90 nPa, less than 80 nPa, less than 70 nPa, less than 60 nPa, less than 50 nPa, less than 40 nPa, less than 30 nPa, less than 20 nPa, or less than 10 nPa.

In one embodiment, prior to the contacting step (a), the target particles may be grown on the stamp substrate. The growing step may comprise growing nanostructures on the stamp substrate to form the target particles. In one embodiment, the nanostructures can be grown by means of vacuum deposition from a solvent containing the target nano-particles, or by thermal evaporation (for example metal vapor deposition) and/or by a thermal annealing process that will induce self-assembly of the nano-particles into polymer chains or metallic nano-islands.

The nanostructures may adopt any structural configuration, including but not limited to, elevated platforms (“nanopads”), cylindrical structures, pillar structures (“nanopillars”), pyramidal structures, conical structures (“nanocones”), wire shaped structures (“nanowires”), domed-shaped structures (“nanodomes”), needle-like structures (“nanoneedles”), tapered structures or a mixture thereof. In one embodiment, the nanostructures may be crystalline (i.e. nanocrystals). In another embodiment, the nanostructures may be irregular in shape or shapeless. In another embodiment, the nanostructures may be in the form of polymeric molecular chains or oligomeric molecular chains.

In yet another embodiment, the nanostructures grown on the stamp substrate may be metallic nanocrystals. The metallic nanocrystals may comprise at least one transition metal element. The transition metal may be selected from the group consisting of: Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au. In one embodiment, the metallic nanocrystals are Gold (Au) nanocrystals.

During contacting step (a), the stamp substrate and the receiver substrate may be compressed under forces of from about 0 N to about 5 N.

In the above disclosed method, the stamp substrate may be selected to be a composite material comprising at least one transition metal element. The transition metal element may be selected from the group consisting of: Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au. In one embodiment, the transition metal element is selected to be Mo. In a particular embodiment, the stamp substrate is composed of MoS₂.

The stamp substrate may be selected for its ability to form specific types nanostructures on its surface, which may be otherwise difficult or impossible to form directly on the receiver substrate surface. For instance, MoS₂ may be selected for the ease of forming the Au nanostructures (e.g. nanoislands) on its relatively flat surface, which cannot otherwise be formed directly on a receiver substrate (e.g. H—Si).

Advantageously, in one embodiment, the above disclosed method may be used for transferring metallic nanostructures provided on a surface of the stamp substrate to a surface of the receiver substrate. Advantageously, by performing the contacting step under UHV conditions, the transfer of nanostructures may be performed without damaging the atomic surface integrity of the receiver substrate.

In one embodiment, the contacting step (a) is performed under room temperature.

Exemplary, non-limiting embodiments of a system according to the second aspect will now be disclosed.

In one embodiment, there is provided a system for transferring target particles between two substrates, said system comprising: (a) a chamber housing at least one stamp substrate and one receiver substrate therein, said stamp substrate having target particles disposed thereon; (b) pressing means configured to bring into contact said stamp substrate and said receiver substrate to transfer said target particles from said stamp substrate to said receiver substrate; and (c) vacuum means capable of generating negative pressure conditions in said chamber, wherein in use, said vacuum means applies a vacuum to said contacting stamp and receiver substrates to prevent non-target particles from being deposited onto said receiver substrate.

The vacuum means may be configured to generate and sustain a pressure condition of 100 nPa or lower within the chamber. Preferably, the pressurizing means may be configured to generate and sustain pressures within the chamber of less than 90 nPa, less than 80 nPa, less than 70 nPa, less than 60 nPa, less than 50 nPa, less than 40 nPa, less than 30 nPa, less than 20 nPa, or less than 10 nPa. Advantageously, the lower the chamber pressure, the lower the incidence of non-target particles being deposited on the receiver substrate.

In the disclosed system, the pressing means may be activated by an electrical means. The electrical means may be integrally provided within the pressing means. The electrical means may be activated from outside of the chamber to actuate the pressing means within the chamber while the chamber is under UHV conditions. In one embodiment, the pressing means is a piezoelectric actuator.

The pressing means may further comprise at least two substrate holders respectively configured to receive and secure a substrate thereon. When activated, the pressing means may be configured to move the substrate holders towards one another to substantially abut the substrates disposed within the substrate holders. The pressing means may be configured to deliver a compressive force of between 0 N (simple contact with no additional force) to 5 N (contact with additional compressive force of 5N).

In another embodiment, the pressing means may be a mechanical means, such as a worm screw configured to move the substrate holders to thereby bring into contact the substrates housed within the substrate holders.

In the disclosed system, the stamp substrate may be a composite material comprising at least one transition metal element. The transition metal element may be selected from the group consisting of: Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au. In one embodiment, the transition metal element is Mo. In another embodiment, the stamp substrate is substantially composed of the composite material MoS₂.

The stamp substrate may comprise nanostructures grown on its surface. The nanostructures may adopt any structural configuration, including but not limited to, elevated platforms (“nano-pads”), cylindrical structures, pillar structures (“nanopillars”), pyramidal structures, conical structures (“nanocones”), wire shaped structures (“nanowires”), domed-shaped structures (“nanodomes”), needle-like structures (“nanoneedles”), tapered structures or a mixture thereof. The nanostructures may be metallic nanostructures. In one embodiment, the nanostructures may be metallic nanocrystals. In another embodiment, the nanostructures may be irregular in shape or shapeless.

In one embodiment, the nanostructures may have a dimension of 50 nm or lesser in width and 15 nm or less in height.

The nanostructures may be composed of a transition metal element selected from the group consisting of: Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au. In one embodiment, the nanostructures comprise Au nanocrystals. In yet another embodiment, the Au nanocrystals are characterized as nano-pads deposited on the surface of the stamp substrate.

In the disclosed system, the receiver substrate may be composed of any suitable material having an atomically resolvable surface. In one embodiment, the receiver substrate comprises silicon or a silicon-based material. In one embodiment, the receiver substrate comprises hydrogen terminated silicon (H—Si). In another embodiment, the receiver substrate comprises Germanium, e.g., hydrogen-terminated Ge (H—Ge).

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows a schematic diagram of a system 100 in accordance with an embodiment of the invention.

FIG. 2a shows a schematic diagram of a piezo element 102 and its component parts (i.e. sample holders 104 and actuator 106).

FIG. 2b shows a photograph of recipient substrate holder 114 in accordance with an embodiment of the disclosure.

FIG. 2c shows a photograph of sample holder 104 in accordance with an embodiment of the disclosure.

FIG. 2d shows a photograph of a stamp substrate holder 212 in accordance with an embodiment of the disclosure.

FIG. 2e shows a schematic diagram of the loading of stamp substrate holder 212 into stamp holder 112.

FIG. 2f shows a photograph of stamp substrate 126 clamped to stamp substrate holder 212.

FIGS. 3a, b and c show scanning electron microscopic (SEM) images of stamp substrate 126 in accordance with an embodiment of the disclosure, at increasing magnification respectively. Specifically, FIG. 3a shows the SEM image of stamp substrate 126 having an ordered array of micron-sized structures 124 thereon. FIG. 3b shows the SEM image of each micron-sized structure 124. FIG. 3c shows the SEM image of the nanostructures 132 formed on each micron-sized structure 124.

FIG. 4 shows the SEM image at 80,000× magnification of a micron-sized MoS₂ structure 124 and gold nanostructures 132 formed thereon in accordance with a specific embodiment of the disclosure and used in Example 1.

FIG. 5 shows a schematic flow diagram of stamp substrate holder 212 and recipient substrate holder 114 having recipient substrate 214 loaded thereon being loaded onto piezo element 102.

FIG. 6 shows the SEM image at 380,000× magnification of the transferred gold nanocrystals on the H—Si substrate obtained in Example 1.

FIG. 7 shows a low temperature scanning tunneling microscopic (LT STM) image of the Si (111) recipient substrate used before transfer printing in the Comparative Example.

FIG. 8 shows SEM images of the Si (111) substrate after transfer printing obtained in the Comparative Example.

FIG. 9 shows the LT STM image of the Si (111) substrate after transfer printing obtained in the Comparative Example.

In the figures, like numerals denote like parts.

### DETAILED DESCRIPTION OF DRAWINGS

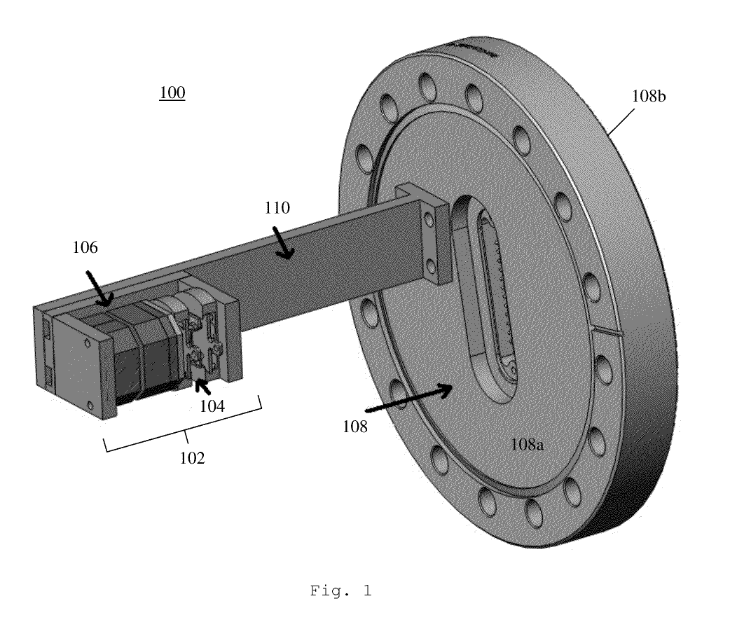

Referring to FIG. 1, a system 100 in accordance with an embodiment of the invention is shown.

System 100 comprises a piezo element 102 made up of an Attocube piezoelectric actuator 106 (from Attocube systems AG, Germany) and a pair of sample holders 104, an ultra high vacuum (UHV) flange 108 and a frame 110.

Frame 110 connects UHV flange 108 with piezo element 102 and holds the components in place. UHV flange 108 is fitted on one side (side 108b) to a pressurizing means (not shown) capable of generating negative pressure conditions, for instance a vacuum pump. A housing (not shown) is fitted on the other side (side 108a) of UHV flange 108 to enclose frame 110 and piezo element 102 so that a UHV environment can be generated. UHV flange 108 also provides an electrical input (not shown) to actuate piezo element 102.

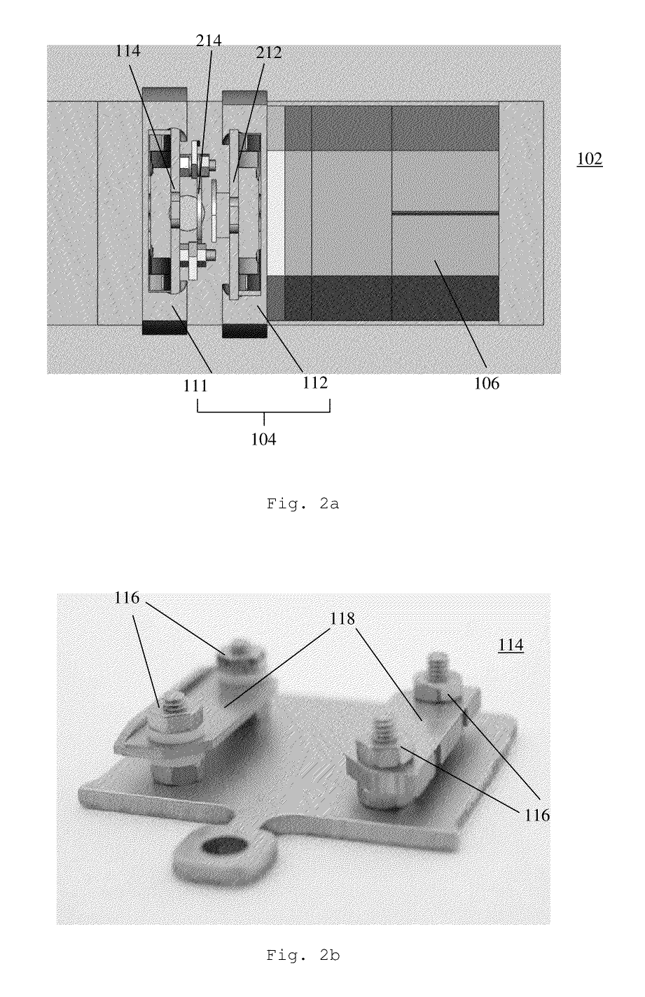

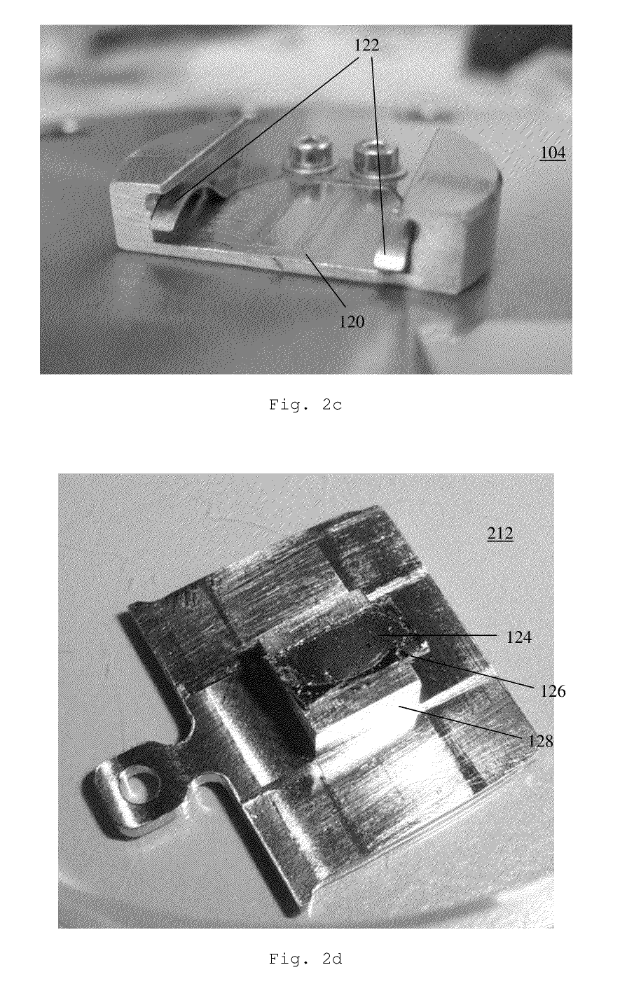

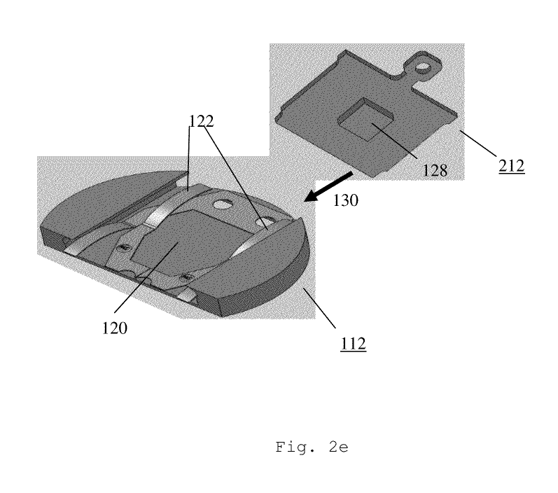

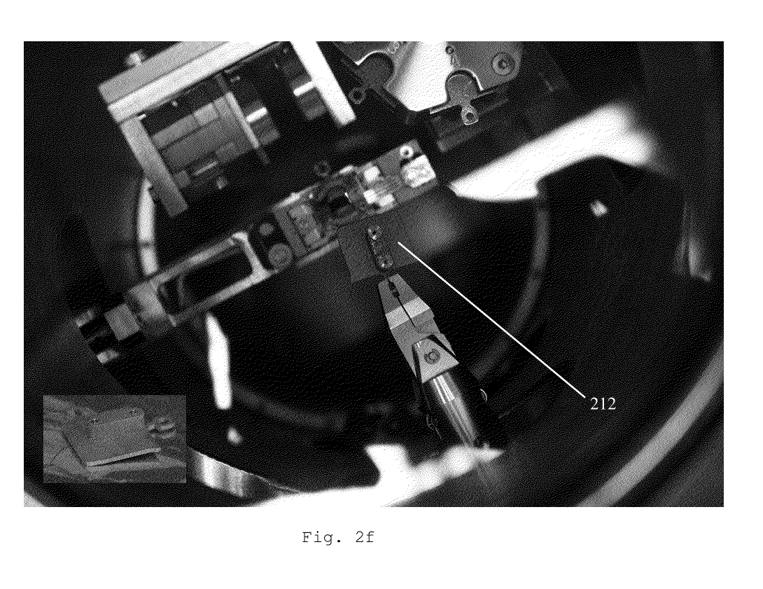

Piezo element 102 will now be described in greater detail. A schematic diagram of piezo element 102 and its component parts (i.e. sample holders 104 and actuator 106) are shown in FIG. 2a. As seen in FIG. 2a, the pair of sample holders 104 comprises of stamp holder 112 and recipient holder 111. Stamp holder 112 is used to receive stamp substrate holder 212, while recipient holder 111 is used to receive recipient substrate holder 114 having recipient substrate 214 loaded thereon.

Photographs of recipient substrate holder 114 and sample holder 104 are shown in FIGS. 2b and 2c respectively. As seen from FIG. 2b, recipient substrate holder 114 receives recipient substrate 214 between top screws 116 and support 118. As explained above, sample holder 104 comprises of stamp holder 112 and recipient holder 111. Accordingly, as seen from FIG. 2c, sample holder 104 can either receive stamp substrate holder 212 or recipient substrate holder 114 between the backing 120 and arms 122.

A photograph of stamp substrate holder 212 in accordance with an embodiment of the disclosure is shown in FIG. 2d. As seen in FIG. 2d, stamp substrate 126 having structures 124 thereon is attached to the surface of platform 128 of stamp substrate holder 212. Stamp substrate 126 may be attached to the surface of platform 128 by UHV compatible glue. Alternatively, as seen in FIG. 2f, stamp substrate 126 may be clamped to stamp substrate holder 212. In this alternative, the clamping permits stamp substrate 126 to be heated, which may not be possible when glue is used.

A schematic diagram showing the loading of stamp substrate holder 212 into stamp holder 112 is shown in FIG. 2e. Referring to FIG. 2e, it can be seen that stamp 212 with platform 128 facing outwards is loaded between the backing 120 and arms 122 of stamp holder 112 along the direction of arrow 130.

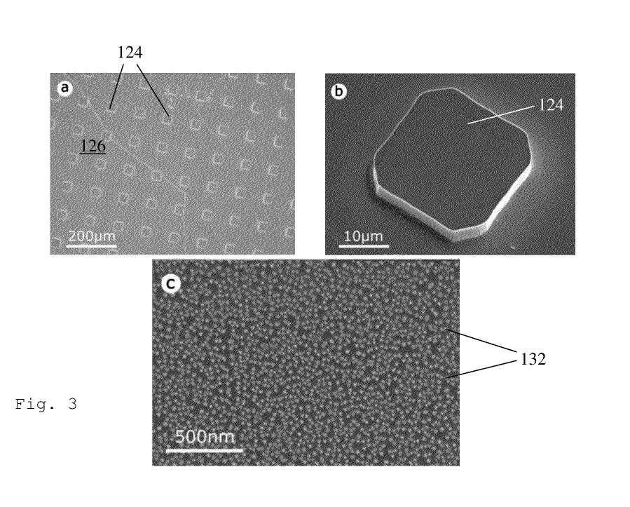

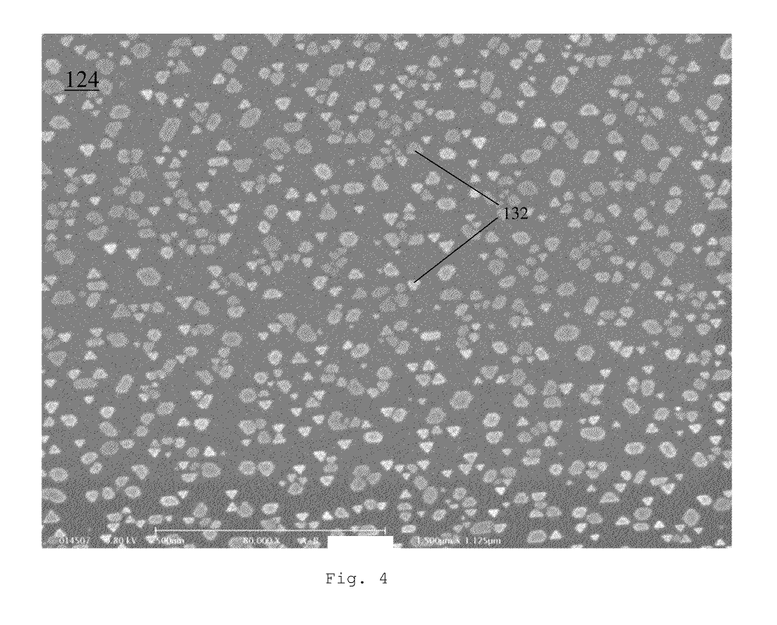

Scanning electron microscopic (SEM) images of stamp substrate 126, in accordance with an embodiment of the disclosure, are shown in FIGS. 3a, b and c with increasing magnification respectively. From FIG. 3a, it can be seen that stamp substrate 126 has an ordered array of micron-sized structures 124 thereon. The SEM image of each micron-sized structure 124 is shown in FIG. 3b. At further magnification, it can be seen in FIG. 3c that each micron-sized structure 124 comprises nanostructures 132 formed thereon.

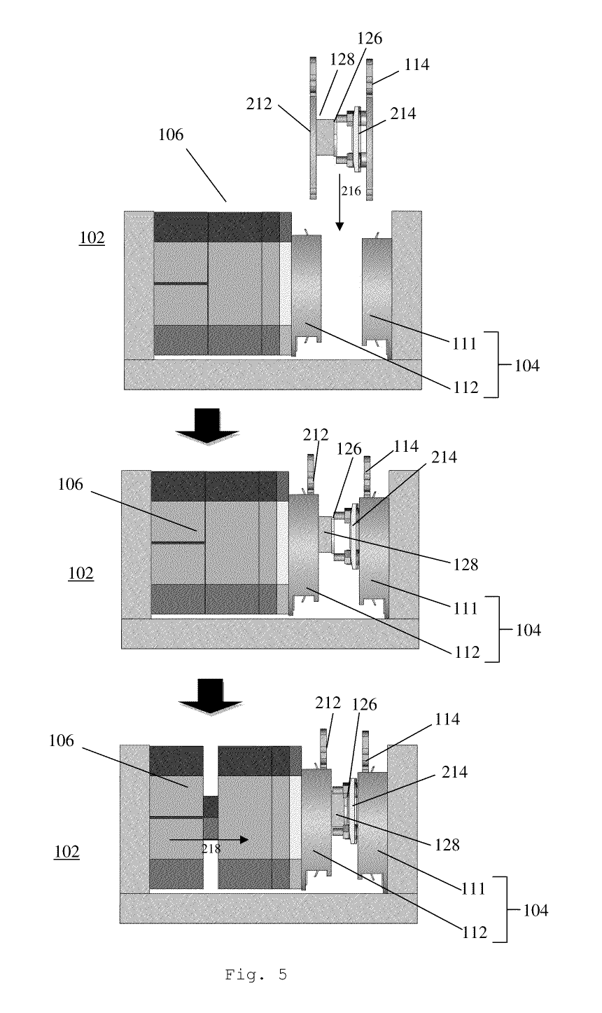

In a specific embodiment of the disclosure, micron-sized structure 124 is made of MoS₂, while nanostructures 132 formed on structure 124 are made of gold crystals. The SEM image of micron-sized structure 124 in accordance with this specific embodiment is shown in FIG. 4 at 80,000× magnification.

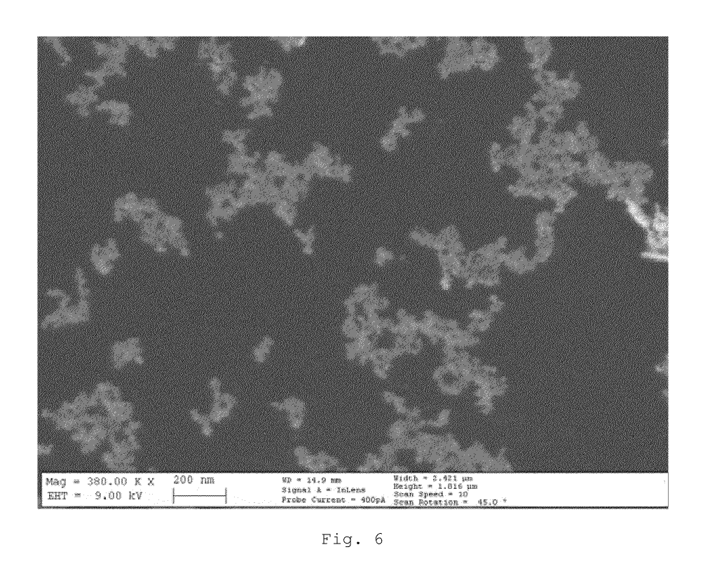

The use of system 100 will now be described with reference to FIGS. 1 and 5. A schematic flow diagram of stamp substrate holder 212 having stamp substrate 126 attached thereon and recipient substrate holder 114 having recipient substrate 214 loaded thereon being loaded onto piezo element 102 is shown in FIG. 5. Stamp substrate 126 is attached onto stamp substrate holder 212 prior to being loaded onto piezo element 102. Recipient substrate 214 is also loaded into recipient substrate holder 114 prior to being loaded onto piezo element 102. Thereafter, stamp substrate holder 212 and recipient substrate holder 114 are loaded into stamp holder 112 and recipient holder 111 respectively in the direction of arrow 216. It can be seen that stamp substrate holder 212 is positioned so that platform 128 having stamp substrate 126 attached thereon faces recipient substrate 214. When stamp substrate holder 212 and recipient substrate holder 114 are loaded securely into stamp holder 112 and recipient holder 111 respectively, a housing (not shown) is securely fitted onto side 108a of UHV flange 108 to enclose frame 110 and piezo element 102 before a UHV environment is generated. Thereafter, a vacuum pump (not shown) fitted to side 108b of UHV flange 108 is started. The vacuum pump is ramped up to a suitable pressure to generate a UHV environment around piezo element 102 and its load within the housing. After the UHV environment has equilibrated, actuator 106 is actuated by an electrical input (not shown) and is released in the direction of arrow 218 by the stick slip motion induced by the motion of actuator 106 so that stamp substrate 126 of stamp substrate holder 212 is pressed onto recipient substrate 214. The nanostructures 132 on structure 124 attached to stamp substrate 126 are thereby transferred to recipient substrate 214.

### EXAMPLES

Non-limiting examples of the invention will be further described in greater detail by reference to specific Examples, which should not be construed as in any way limiting the scope of the invention.

### Example 1

A stamp substrate comprising micron-sized MoS₂ substrates having gold nanocrystals thereon, as shown in FIG. 4, was loaded into the stamp holder of the disclosed system.

A H—Si substrate was used as the recipient substrate. The H—Si substrate was prepared in situ under UHV from a piece of Si substrate. The Si substrate may be purchased, for example, from MTI Corporation, California, USA. The prepared H—Si substrate was then loaded into the recipient holder.

A UHV environment of 10 nPa was then allowed to equilibrate. After the pressure stabilized, the Attocube piezoelectric actuator (from Attocube systems AG, Germany) was actuated and the gold nanocrystals were transferred to the H—Si substrate.

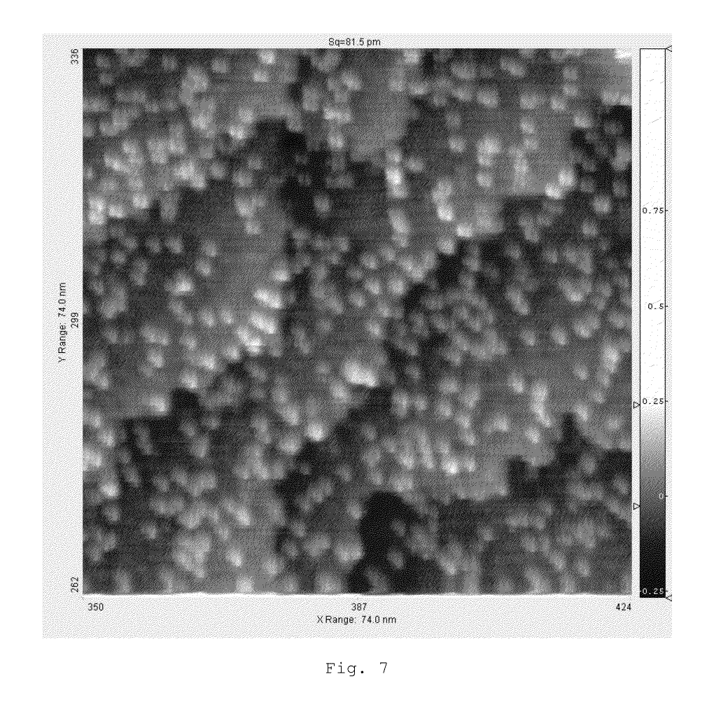

An SEM image at 380,000× magnification of the transferred gold nanocrystals on the H—Si substrate is shown in FIG. 6. It can be seen from FIG. 6 that the transferred gold nanocrystals cover a large part of the H—Si recipient substrate.

### Example 2

In this example, low temperature scanning tunneling microscopy (LT STM) was additionally used to image the recipient substrate and stamp substrate.

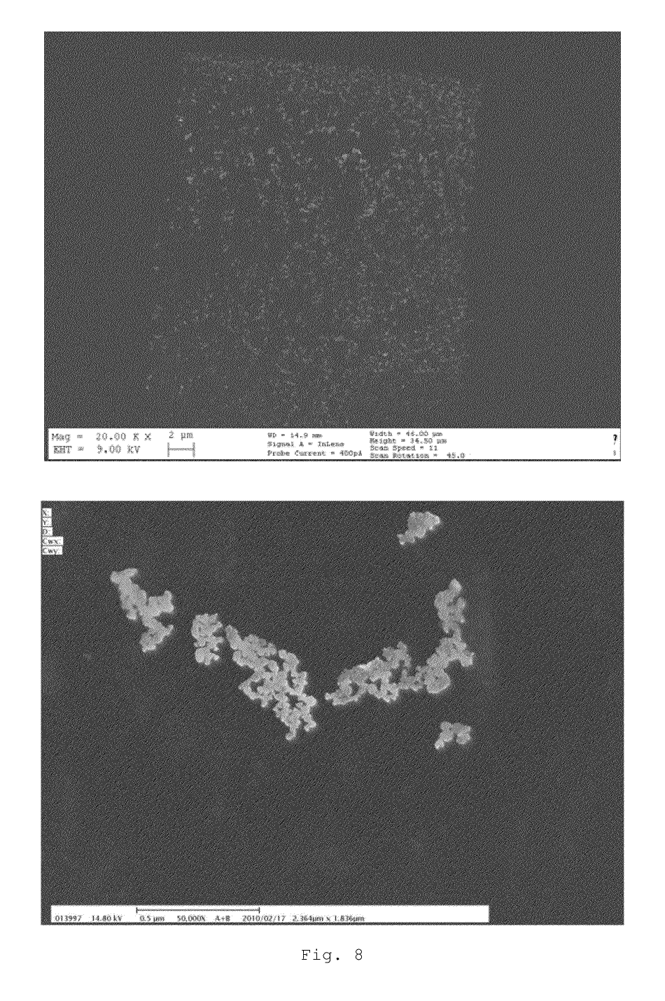

The recipient substrate used here was a flashed Si (111) substrate prepared in situ in a UHV environment of about 10 nPa. An LT STM image of the Si (111) recipient substrate, taken at 4 Kelvin in a UHV environment before transfer printing, is shown in FIG. 7. The Si terraces of the recipient substrate can clearly be seen in FIG. 7.

The stamp substrate used here was composed of a MoS₂ substrate with square pillars of about 30 micrometers in length and 8 micrometers tall patterned thereon. Gold nanocrystals were formed in situ under UHV on the MoS₂ substrate by depositing gold crystals of 1 nm in size on the stamp substrate held at a temperature of about 400° C.

After the stamp substrate was cooled down, the stamp substrate was brought ex situ and loaded into the stamp holder of the disclosed system. The Si (111) recipient substrate was also loaded into the recipient holder of the disclosed system.

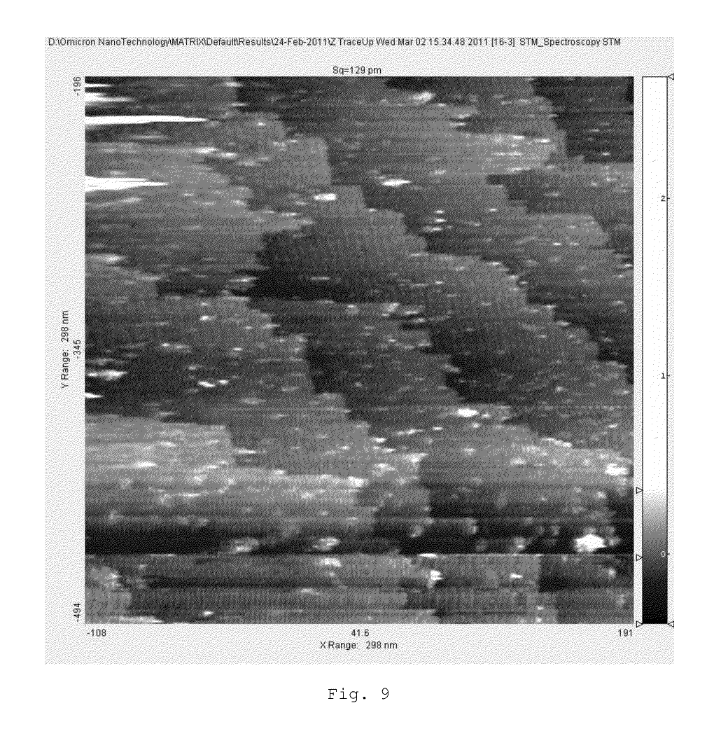

The transfer was then performed in a UHV environment of about 10 nPa by bringing the patterned MoS₂ stamp substrate and the Si (111) recipient substrate in contact with a maximum force of about 5N as allowed by the Attocube actuator. After the transfer process, the Si (111) recipient substrate was brought in situ under UHV to a SEM followed by a LT STM. The SEM and LT STM images of the Si (111) recipient substrate surface after the transfer are shown in FIGS. 8 and 9 respectively.

Comparing FIG. 7 and FIG. 9, it is clear that the Si terraces even after the transfer process can still be resolved with the same definition as before the transfer process, and did not get smeared or more contaminated by the transfer process. Accordingly, the disclosed system advantageously enables the transfer of nanoparticles onto a recipient substrate without damaging the original atomic order of the recipient substrate.

### APPLICATIONS

The disclosed method and system are useful for nanoscale fabrication and/or characterization of devices/materials where a receiver substrate surface is required to retain its atomic surface integrity during and after an imprinting step whereby nanoparticles may be transferred from a stamp substrate to the receiver substrate. The disclosed method and system are also useful for depositing nanomaterials/nanostructures on a receiver substrate, which may be otherwise difficult or impossible to grow directly on the receiver substrate.

Advantageously, with the above disclosed method and system, the transfer of nanoparticles (with or without shape) from a solid stamp onto an atomically defined receiver substrate may be performed without damaging the atomic order of the receiver substrate. An important implication is that the disclosed method is not restricted to particular types of receiver substrates as long as the substrates are UHV-compatible. Additionally, as the transfer is carried out under UHV conditions, the risk of contamination by non-target nanoparticles is substantially reduced or avoided completely.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method for transferring target particles between two substrates, the method comprising the steps of:
(a) contacting a receiver substrate with a stamp substrate having said target particles disposed thereon to transfer said target particles to said receiver substrate; and
(b) applying a vacuum to said contacting substrates during said contacting step to prevent non-target particles from being deposited onto said receiver substrate.

2. The method of claim 1, wherein said applying step (b) comprises applying a vacuum pressure of 100 nPa or lower.

3. The method of claim 1, wherein prior to step (a), target particles are provided on the stamp substrate in the form of nanostructures.

4. The method of claim 3, wherein said nanostructures are nanocrystals, polymeric molecular chains, oligomeric molecular chains, or a mixture thereof.

5. The method of claim 4, wherein said nanostructures comprise a transition metal element.

6. The method of claim 5, wherein said transition metal is selected from the group consisting of: Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au.

7. The method of claim 6, wherein said nanostructures are gold nanocrystals.

8. The method of claim 1, wherein during contacting step (a), said stamp substrate and said receiver substrate are contacted under a compressive force of from 0 N to 5 N.

9. The method of claim 1, wherein said stamp substrate is selected to be a composite material comprising a transition metal element.

10. The method of claim 9, wherein said transition metal element is selected from the group consisting of: Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au.

11. The method of claim 10, wherein said transition metal element is selected to be Mo.

12. The method of claim 11, wherein said stamp substrate is comprised of MoS₂.

13. A system for transferring target particles between two substrates, said system comprising:
(a) a chamber housing at least one stamp substrate and one receiver substrate therein, said stamp substrate having target particles disposed thereon;
(b) pressing means configured to bring into contact said stamp substrate and said receiver substrate to transfer said target particles from said stamp substrate to said receiver substrate; and
(c) vacuum means capable of generating negative pressure conditions in said chamber,
wherein in use, said vacuum means applies a vacuum to said contacting stamp and receiver substrate to prevent non-target particles from being deposited onto said receiver substrate.

14. The system of claim 13, wherein said vacuum means is configured to generate pressures of 100 nPa or lower within said chamber.

15. The system of claim 13, wherein said pressing means is activated by an integrated electrical means or a mechanical means.

16. The system of claim 15, wherein said pressing means is a piezoelectric actuator.

17. The system of claim 13, wherein said stamp substrate is a composite material comprising a transition metal element.

18. The system of claim 17, wherein said transition metal element is selected from the group consisting of: Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au.

19. The system of claim 18, wherein said transition metal element is Mo.

20. The system of claim 19, wherein said composite material is MoS₂.

21. The system of claim 13, wherein said target particles comprise nanostructures provided on a surface of said stamp substrate.

22. The system of claim 21, wherein said nanostructures are nanocrystals, polymeric molecular chains, oligomeric molecular chains or a mixture thereof.

23. The system of claim 22, wherein said nanostructures comprises a transition metal element selected from the group consisting of: Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au.

24. The system of claim 23, wherein said nanostructures are gold nanocrystals.

25. The system of claim 13, wherein said receiver substrate comprises Silicon or Germanium.

26. The system of claim 25, wherein said receiver substrate comprises hydrogen-terminated silicon (H—Si) or hydrogen-terminated Germanium (H—Ge).
